(19) United States
(12) Patent Application Publication
(10) Pub. No.: US 2012/0134743 A1
(43) Pub. Date: May 31, 2012

(54) MOUNTING APPARATUS FOR SLIDE RAIL

(75) Inventors: MO-MING YU, Shenzhen City (CN); ZE-HONG CHEN, Shenzhen City (CN)

(73) Assignees: HON HAI PRECISION INDUSTRY CO., LTD., Tu-Cheng (TW); HONG FU JIN PRECISION INDUSTRY(Shenzhen) CO., LTD., Shenzhen City (CN)

(21) Appl. No.: 12/965,826

(22) Filed: Dec. 11, 2010

(30) Foreign Application Priority Data
Nov. 26, 2010 (CN) 201010561581.8

(51) Int. Cl. F16B 21/06

(52) U.S. Cl. 403/330

(57) ABSTRACT

A mounting apparatus for mounting a slide rail to a bracket with a number of through holes, the mounting apparatus includes a retaining member, a pivoting member pivotably attached to the retaining member, an operating member fixed to the pivoting member and attached to the retaining member, and a resilient member arranged between the pivoting member and the retaining member. A first positioning portion extends from one side of the retaining member. The pivoting member includes a first locking block. The operating member is operated to rotate the pivoting member to make the first locking block and the first positioning portion align with two corresponding through holes of the bracket. When releasing the operating member, the resilient member is restored to rotate the pivoting member to make the first locking block lock to the bracket.

### BACKGROUND

1. Technical Field

The disclosure relates to mounting apparatuses, and more particularly to a mounting apparatus for mounting a slide rail.

2. Description of Related Art

A slide rail is used between two objects that can move relative to each other, such as between a desk and a drawer, or a server and a rack. A conventional slide rail assembly for a drawer and a desk includes an outer slide rail mounted to the desk, an inner slide rail mounted to the drawer, and an intermediate slide rail mounted between the outer and inner slide rails. The intermediate slide rail is extendable relative to the outer slide rail, and the inner slide rail is extendable relative to the intermediate slide rail, thus the drawer can be extended a short distance out from the desk. A plurality of screws is used for mounting the outer slide rail to the desk. Therefore, installing or uninstalling the outer slide rail to or from the desk is inconvenient and time-consuming.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an embodiment of a mounting apparatus for a slide rail, mounted to a first bracket.

FIG. 2 is similar to FIG. 1, but viewed from another perspective.

FIG. 3 is an exploded, isometric view of the mounting apparatus of FIG. 1.

FIG. 4 is an assembled, isometric view of the mounting apparatus of FIG. 3, but viewed from another perspective.

FIG. 5 is an assembled, isometric view of the mounting apparatus for a slide rail of FIG. 1, mounted to a second bracket.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

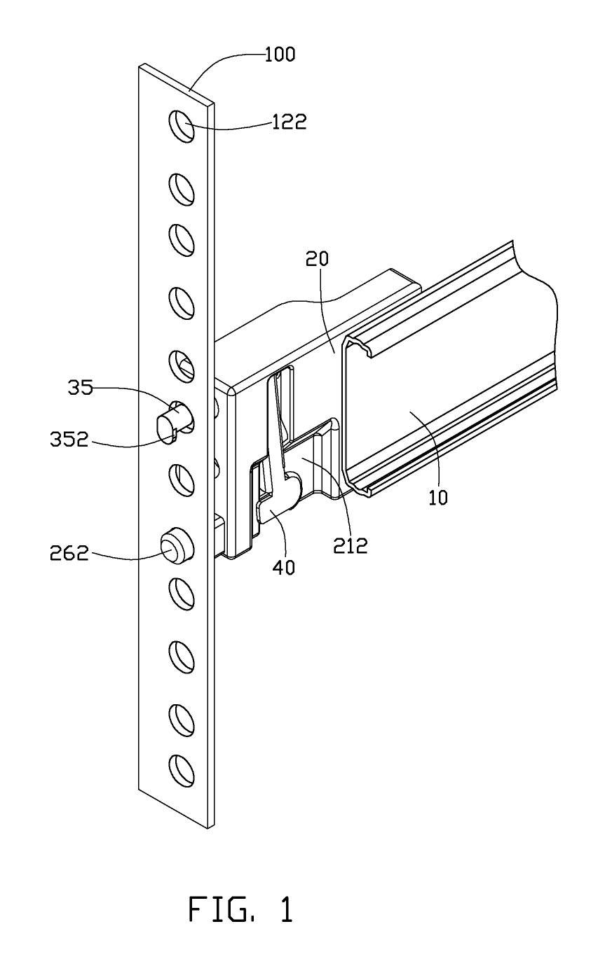

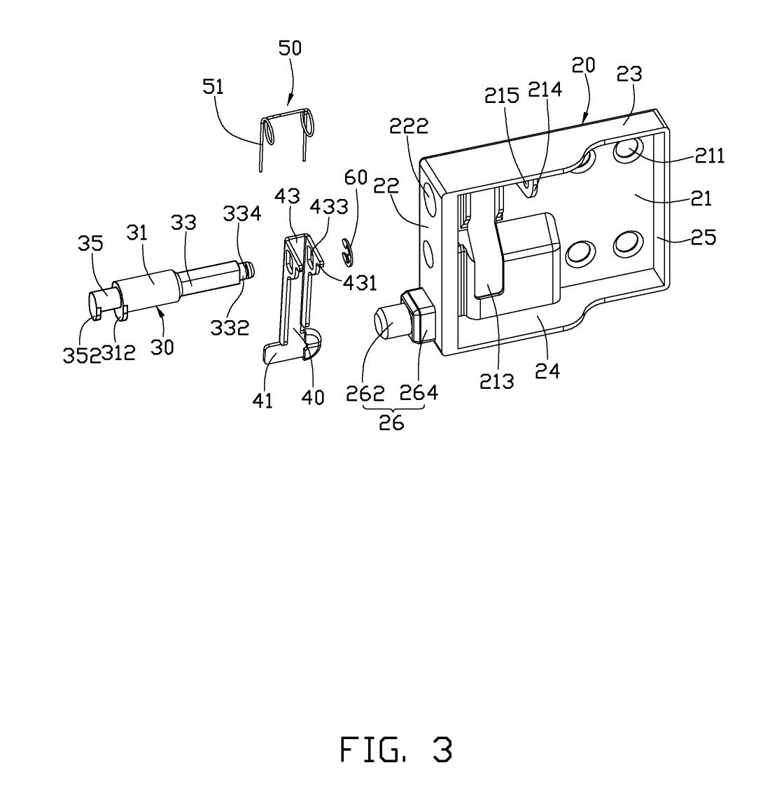

Referring to FIGS. 1 to 3, an exemplary embodiment of a mounting apparatus is provided for mounting a slide rail 10 to a first bracket 100. The mounting apparatus includes a retaining member 20, a pivoting member 30, an operating member 40, a resilient member 50, and a fastener 60.

The first bracket 100 includes a flange with a plurality of through holes 122 defined therein from top to bottom.

The retaining member 20 is substantially a box with an opening, and includes a main wall 21, a first sidewall 22, a second sidewall 23, a third sidewall 24, and a fourth sidewall 25 substantially perpendicularly extending from four sides of the main wall 21. The main wall 21 defines a plurality of mounting holes 211 adjacent to the fourth sidewall 25, for mounting the retaining member 20 to an end of the slide rail 10. The main wall 21 defines a receiving space 212 opposite to the first to fourth sidewalls 22-25, and a through hole 213 communicating with the receiving space 212. A mounting piece 214 extends from an inner surface of the main wall 21 adjacent to the second sidewall 23. The mounting piece 214 defines a round through hole 215. The first sidewall 22 defines a pivoting hole 222 adjacent to the second sidewall 23. The pivoting hole 222 aligns with the through hole 215 of the mounting piece 214. A positioning pole 26 extends outward from the first sidewall 22 adjacent to the third sidewall 24. The positioning pole 26 is substantially stepped and includes a round first positioning portion 262, with a rectangle-shaped second positioning portion 264 extending from the first sidewall 22. The first positioning portion 262 extends from the second positioning portion 264.

The pivoting member 30 is substantially pole shaped, and includes a round pivoting portion 31 at a middle of the pivoting member 30, and a non-circular fixing portion 33 and a locking portion 35 extending from opposite ends of the pivoting portion 31. The locking portion 35 is substantially a column. A first locking block 352 extends from a circumference of a distal end of the locking portion 35 opposite to the pivoting portion 31. The pivoting portion 31 forms a second locking block 312 extending from a circumference of the pivoting portion 31 adjacent to the locking portion 35. A diameter of the pivoting portion 31 is larger than a diameter of the locking portion 35. A clip portion 332 extends from a distal end of the fixing portion 33 opposite to the pivoting portion 31. An annular slot 334 is defined in a circumference of the clip portion 332.

The operating member 40 includes a handle 41 and a connecting portion 43 respectively at opposite ends of the operating member 40. The connecting portion 43 includes two parallel tabs 431 substantially perpendicular to the handle 41. Each tab 431 defines a non-circular mounting hole 433. The shape of the mounting holes 433 is same as a cross-section of the fixing portion 33 of the pivoting member 30. In this embodiment, the cross-section of the fixing portion 33 is non-circular.

The resilient member 50 is a torsion spring, and includes two arms 51.

In this embodiment, the fastener 60 is a substantially E-shaped snap ring.

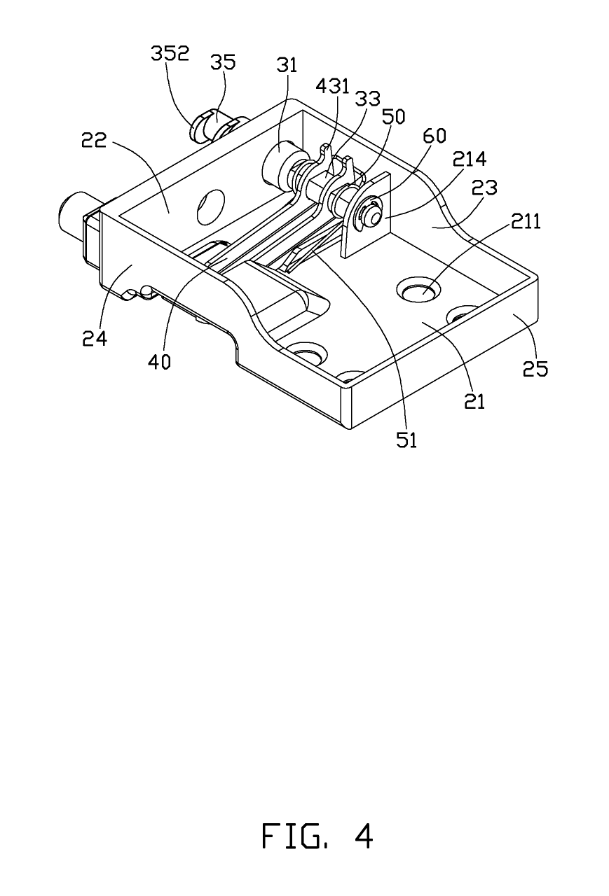

Referring to FIG. 4, in assembly, the fixing portion 33 of the pivoting member 30 extends through the pivoting hole 222 of the first sidewall 22 of the retaining member 20. The resilient member 50 is set around the fixing portion 33. The arms 51 of the resilient member 50 are blocked by the main wall 21 of the retaining member 20. The operating member 40 is accommodated in the receiving space 212 of the retaining member 20, with the connecting portion 43 of the operating member 40 extending through the through hole 213 of the retaining member 20. The mounting holes 433 of the operating member 40 are set around the fixing portion 33. The handle 41 of the operating member 40 is received in the receiving space 212. The clip portion 332 of the pivoting member 30 extends through the through hole 215 of the mounting piece 214 of the retaining member 20. The fastener 60 engages in the annular slot 334 of the pivoting member 30 and is blocked by the mounting piece 214 to prevent the pivoting member 30 from disengaging from the mounting piece 214.

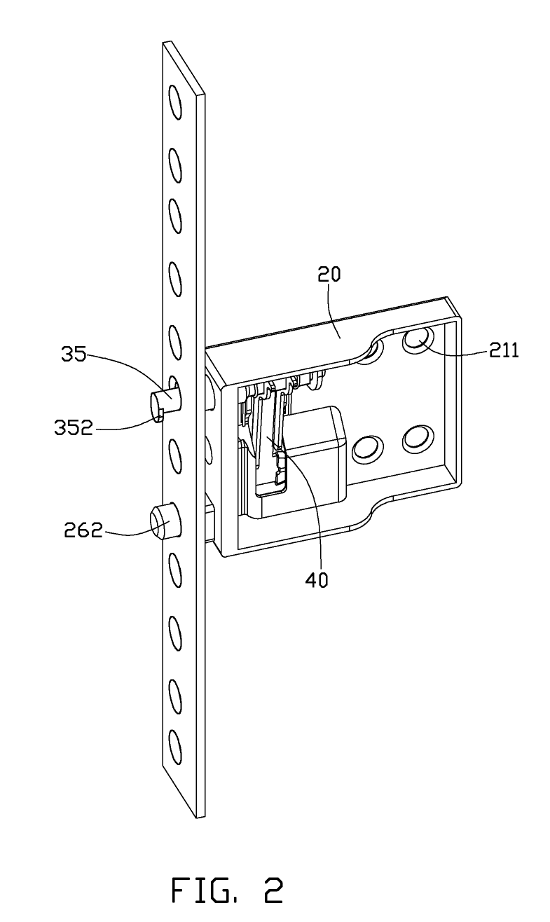

Referring to FIGS. 1 to 2 again, in mounting the slide rail 10 to the first bracket 100, the handle 41 of the operating member 40 is operated to move away from the main wall 21 to make the pivoting member 30 rotate until the first locking block 352 is horizontal. The first locking block 352 of the pivoting member 30 aligns with a lower portion of a corresponding through hole 122 of the first bracket 100. The first positioning portion 262 of the retaining member 20 aligns with another through hole 122. An axis of the locking portion 35 is offset from an axis of the through hole 122. The retaining member 20 is moved toward the first bracket 100 to make the first positioning portion 262 and the first locking block 352 engage in the corresponding through holes 122. The handle 41 of the operating member 40 is then released. The resilient member 50 is restored to drive the operating member 40 to move toward the main wall 21 of the retaining member 20. The pivoting member 30 is rotated to make the first locking block 352 to be upright to lock the first bracket 100.

In releasing the slide rail 10 from the first bracket 100, the handle 41 of the operating member 40 is operated to move away from the main wall 21 to make the pivoting member 30 rotate until the first locking block 352 is horizontal, then the retaining member 20 is moved away from the first bracket 100.

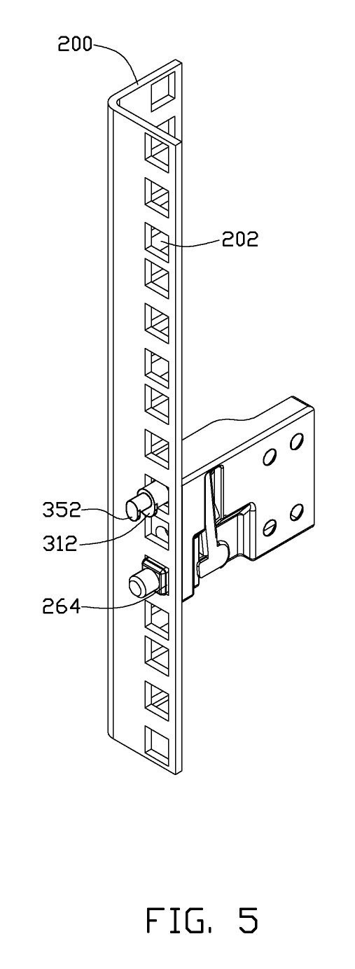

Referring to FIG. 5, in mounting or releasing the slide rail 10 to or from a second bracket 200 with a plurality of rectangle-shaped through holes 202, the principle of the operation is the same as mounting the slide rail 10 to the first bracket 100. However, the second locking block 312 and the second positioning portion 264 are engaged in the corresponding through holes 202 of the second bracket 200.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A mounting apparatus for mounting a slide rail to a bracket, the bracket defines a plurality of through holes, the mounting apparatus comprising:
a retaining member fixed to the slide rail with a first end, a first positioning portion extending from a second end of the retaining member opposite to the first end;
a pivoting member pivotably attached to the retaining member, the pivoting member comprising a locking portion, a first locking block extending from a first end of the locking portion;
an operating member fixed to the pivoting member to pivoting together with the pivoting member and attached to the retaining member; and
a resilient member arranged between the pivoting member and the retaining member;
wherein the operating member is operated to rotate the pivoting member to make the first locking block and the first positioning portion align with two corresponding through holes of the bracket, then the operating member is released, the resilient member is restored to rotate the pivoting member to make the first locking block be locked to the bracket.

2. The mounting apparatus as described in claim 1, wherein the retaining member comprises a main wall, and a first sidewall, a second sidewall, a third sidewall, and a fourth sidewall perpendicularly extending from sides of the main wall, a mounting piece extends from an inner surface of the main wall, the mounting piece defines a round through hole, the first sidewall defines a pivoting hole aligning with the through hole of the mounting piece, the pivoting member pivotably extends through the pivoting hole and the through hole of the mounting piece.

3. The mounting apparatus as described in claim 2, wherein a clip portion extends from a second end of the pivoting member opposite to the first locking block, an annular slot is defined in a circumference of the clip portion, the clip portion extends through the through hole of the mounting piece, a fastener engages in the annular slot and is blocked by the mounting piece to prevent the pivoting member from disengaging from the mounting piece.

4. The mounting apparatus as described in claim 3, wherein the fastener is a substantially E-shaped snap ring.

5. The mounting apparatus as described in claim 2, wherein a positioning pole extends outward from the first sidewall of the retaining member, the first positioning portion extends from the positioning pole, for engaging with the bracket.

6. The mounting apparatus as described in claim 2, wherein the main wall defines a receiving space and a through hole communicating with the receiving space, the operating member comprises a connecting portion and a handle at opposite ends of the operating member, the connecting portion extends through the through hole of the retaining member from an outer surface of the main wall to an inner surface of the main wall, the handle of the operating member is received in the receiving space.

7. The mounting apparatus as described in claim 2, wherein the pivoting member comprises a round pivoting portion at a middle of the pivoting member, a non-circular fixing portion and the locking portion extend from opposite ends of the pivoting portion, the first locking block extends from a circumference of a distal end of the locking portion, the pivoting portion is pivotably received in the pivoting hole of the retaining member.

8. The mounting apparatus as described in claim 1, wherein an axis of the locking portion is offset from an axis of the through hole.

9. A mounting apparatus for selectively mounting a slide rail to a first bracket or a second bracket, the first bracket defines a plurality of first through holes, the second bracket defines a plurality of second through holes, the mounting apparatus comprising:
a retaining member fixed to the slide rail with a first end, a positioning pole extending from a second end of the retaining member, the positioning pole comprising a first positioning portion and a second positioning portion;
a pivoting member pivotably attached to the retaining member, the pivoting member comprising a locking portion, the locking portion comprising a first locking block and a second locking block;
an operating member fixed to the pivoting member to pivoting with the pivoting member and attached to the retaining member; and
a resilient member arranged between the pivoting member and the retaining member;
wherein when mounting the slide rail to the first bracket, the operating member is operated to rotate the pivoting member to make the first locking block and the first positioning portion align with two corresponding first through holes of the first bracket, then the operating member is released, the resilient member is restored to rotate the pivoting member to make the first locking block be locked to the first bracket; and
wherein when mounting the slide rail to the second bracket, the operating member is operated to rotate the pivoting member to make the second locking block and the second positioning portion align with two corresponding second through hole of the second bracket, then the operating member is released, the resilient member is restored to rotate the pivoting member to make the second locking block be locked to the second bracket.

10. The mounting apparatus as described in claim 9, wherein the retaining member comprises a main wall, and a first sidewall, a second sidewall, a third sidewall, and a fourth sidewall perpendicularly extending from sides of the main wall, a mounting piece extends from an inner surface of the main wall, the mounting piece defines a round through hole, the first sidewall defines a pivoting hole aligning with the through hole of the mounting piece, the pivoting member extends through the pivoting hole and the through hole of the mounting piece.

11. The mounting apparatus as described in claim 10, wherein a clip portion extends from one end of the pivoting member opposite to the first locking block, an annular slot is defined in a circumference of the clip portion, the clip portion extends through the through hole of the mounting piece, a fastener engages in the annular slot and is blocked by the mounting piece to prevent the pivoting member from disengaging from the mounting piece.

12. The mounting apparatus as described in claim 11, wherein the fastener is a substantially E-shaped snap ring.

13. The mounting apparatus as described in claim 10, wherein the positioning pole extends from the first sidewall and is substantially stepped, the second positioning portion is substantially rectangle-shaped and extends from the first sidewall, and the first positioning portion extends from the second positioning portion.

14. The mounting apparatus as described in claim 10, wherein the main wall defines a receiving space and a through hole communicating with the receiving space, the operating member comprises a connecting portion and a handle at opposite ends of the operating member, the connecting portion of the operating member extends through the through hole of the retaining member from an outer surface of the main wall to an inner surface of the main wall, the handle of the operating member is received in the receiving space.

15. The mounting apparatus as described in claim 10, wherein the pivoting member comprises a round pivoting portion at a middle of the pivoting member, a non-circular fixing portion and the locking portion extend from opposite ends of the pivoting portion, the pivoting portion is pivotably received in the pivoting hole of the retaining member.

16. The mounting apparatus as described in claim 15, wherein the first locking block extends from a circumference of a distal end of the locking portion, the second locking block is formed from the pivoting portion adjacent to the locking portion.

17. The mounting apparatus as described in claim 15, wherein a diameter of the pivoting portion is larger than a diameter of the locking portion.

18. The mounting apparatus as described in claim 9, wherein an axis of the locking portion is offset from an axis of the through hole of the first or second bracket.

19. The mounting apparatus as described in claim 9, wherein the locking portion and the first positioning portion are columnar.

20. The mounting apparatus as described in claim 9, wherein the second positioning portion is rectangle.
